(19) United States
(12) Patent Application Publication
(10) Pub. No.: US 2026/0276311 A1
(43) Pub. Date: Sep. 17, 2026

(54) HEAT EXCHANGER FOR A SOLID BULK MATERIAL

(71) Applicant: Polymetrix AG, Oberbüren (CH)

(72) Inventors: Andreas CHRISTEL, Zuzwil (CH); Rudolf KURATLI, Niederwil (CH)

(73) Assignee: Polymetrix AG, Oberbüren (CH)

(21) Appl. No.: 19/167,125

(22) PCT Filed: Mar. 1, 2024
(86) PCT No.: PCT/EP2024/055320

§ 371 Date: Sep. 19, 2025

(30) Foreign Application Priority Data
Mar. 21, 2023 (EP) 23163005.4

(51) Int. Cl. F28D 13/00; B29B 13/02; B29K 67/00

(52) U.S. Cl. CPC F28D 13/00; B29B 13/02; B29K 2067/003

(57) ABSTRACT

The present invention relates to a heat exchanger (1) for a solid bulk material, comprising a casing (2), a treatment space (6) located within the casing (2) and having the form of a substantially vertically oriented hollow cylinder, wherein the hollow cylinder is limited by an inner cylinder wall (5) and by an outer cylinder wall (9), wherein the inner cylinder wall (5) and the outer cylinder wall (9) are gas-permeable, but the particles of the solid bulk material cannot substantially pass through the cylinder walls (5, 9), and the inner cylinder wall (5) has a height (h1) which is greater than the height (h2) of the outer cylinder wall (9).

The present invention relates to a process and an apparatus for the thermal treatment of a solid bulk material, for example polycondensates, in particular polyesters such as polyethylene terephthalate (PET).

Solid bulk materials often have to undergo thermal treatment such as heating, drying or cooling. For example, in the well-known solid-phase post-condensation of polyethylene terephthalate (PET), in addition to crystallization of amorphous PET into semi-crystalline PET before the actual stage of solid-phase post-condensation, the semi-crystalline PET is heated in a preheater in a uniform and controlled manner to a temperature that is in the range of the temperature used in solid-phase post-condensation or just below.

Conventional heat exchangers consist of a shaft-like container into which the material to be treated is continuously fed so that it reaches an essentially constant level in the container. It sinks uniformly under the influence of gravity, while a process gas flows through it. The process gas is usually introduced and discharged through roof-shaped internals arranged transversally to the direction of movement of the solid bulk material. In this way, the solid bulk material is uniformly supplied with process gas. The pressure losses are comparatively low. The roof-shaped internals cause a certain amount of loosening within the solid bulk material, which reduces the risk of formation of agglomerates and bridges, which particularly occurs when treating plastic pellets.

DE 43 00 913 A1 describes a corresponding heat exchanger in which the solid bulk material is subjected to uniform treatment throughout the entire treatment chamber and over the length of the roof-shaped internals. In particular, means are provided to increase the inlet resistance for the process gas as it flows into the treatment chamber under the roofs, thus creating a region of higher pressure that distributes the process gas uniformly across the inlet cross-sections. This ensures that all the first internals intended for feeding the process gas into the treatment chamber receive essentially the same gas inlet quantities.

However, the manufacturing efforts for such heat exchangers with specific internals are not insignificant.

In WO 99/18404 A1, a heat exchanger was proposed in which, in a conventional dryer with a round or rectangular cross-section, a channel is arranged the side walls of which are made from elements such as perforated plates.

This heat exchanger is still not optimal. The process gas must be fed through gas inlets over the entire height of the heat exchanger and guided through the centrally arranged channel in which the solid bulk material is located. In addition to the associated equipment efforts, the heat exchange achieved with the solid bulk material is also limited.

It was the problem of the present invention to provide an improved heat exchanger and an improved process for the thermal treatment of a solid bulk material.

This problem is solved by the subject-matter of the present application.

More specifically, the present invention relates to a heat exchanger for a solid bulk material, comprising
a jacket,
a treatment chamber arranged within the jacket, which is connected to a product inlet in the upper region of the heat exchanger and at least one product outlet in the lower region of the heat exchanger and has the shape of a substantially vertically aligned hollow cylinder, wherein the hollow cylinder is delimited by an inner cylinder wall and by an outer cylinder wall,
an inner cylindrical gas chamber within the inner cylinder wall of the treatment chamber, which is connected to a gas inlet,
an outer hollow cylindrical gas chamber between the outer cylinder wall of the treatment chamber and the jacket of the heat exchanger, which is connected to a gas outlet, wherein the inner cylinder wall and the outer cylinder wall are gas-permeable, but the particles of the solid bulk material substantially cannot pass through the cylinder walls,
   characterized in that the inner cylinder wall has a height which is greater than the height of the outer cylinder wall.

The present invention further relates to a method for heat treating a solid bulk material in a heat exchanger according to the present invention, comprising the steps of:
a) Introducing the solid bulk material into the heat exchanger through the product inlet of the heat exchanger so that the solid bulk material enters the treatment chamber of the heat exchanger and flows through the heat exchanger from top to bottom to the at least one product outlet;
b) Introducing a process gas through the gas inlet of the heat exchanger into the inner gas chamber of the heat exchanger, the gas having a temperature which is different from the temperature of the solid bulk material;
c) Heat treatment of the solid bulk material in the treatment chamber by flowing gas from the inner gas chamber through the treatment chamber, wherein the gas flows essentially horizontally from the inner gas chamber through the inner cylinder wall and subsequently through the outer cylinder wall into the outer gas chamber;
d) Discharge the gas from the outer gas chamber through the gas outlet of the heat exchanger.

In the heat exchanger according to the invention, the gas required for thermal treatment is fed into an inner gas chamber, which is located inside the treatment chamber with the solid bulk material. The gas is distributed uniformly within the inner gas chamber. As the inner gas chamber is closed at the top, the gas can only pass through the inner cylinder wall of the heat exchanger, which forms the boundary wall between the inner gas chamber and the treatment chamber. The inner cylinder wall is permeable to gas, but essentially does not allow the passage of particles of the solid bulk material.

According to the invention, “essentially” is understood to mean that at most 0.001% of all particles of the solid bulk material can pass through the corresponding cylinder wall.

The gas flows essentially horizontally through the solid bulk material present in the treatment chamber and reaches the outer cylinder wall, which is the boundary wall between the treatment chamber and an outer gas chamber. The outer cylinder wall is permeable to gas, but essentially does not allow particles of the solid bulk to pass through. The gas is finally led out of the heat exchanger from the outer gas chamber.

In addition to the simplification of the apparatus compared to the heat exchanger of WO 99/18404 A1, in that the gas only has to be fed in or discharged through one gas inlet or one gas outlet, the heat exchanger according to the invention can be fed with a larger quantity of gas because the inner cylinder wall has a height that is greater than the height of the outer cylinder wall. Although the dimensions of the heat exchanger remain unchanged (the treatment chamber and the gas chambers are located inside the heat exchanger), more gas can be fed through the inner gas chamber into the treatment chamber in this way.

The heat exchanger according to the invention is not particularly limited in terms of its dimensions and can have the usual dimensions for a heat exchanger, for example a diameter of up to 3 m and a height of up to 10 m.

The heat exchanger according to the invention is delimited by a jacket. The jacket is preferably of rectangular or circular cross-section and made of a suitable material such as a metal, for example steel.

The two gas chambers and the treatment chamber are provided inside the jacket, as described below.

The inner gas chamber is used to feed process gas into the heat exchanger. It is a cylindrical space whose cylindrical axis preferably coincides with an axis of rotation of the heat exchanger. In other words, the inner gas chamber is arranged symmetrically around an axis of rotation of the heat exchanger.

The inner gas chamber is connected to a gas inlet which is preferably located in the lower region of the heat exchanger. The term “lower region” refers to the lower half, preferably the lower third and particularly preferably the lower quarter of the heat exchanger.

Any standard gas inlet can be used. Preferably, the gas inlet can be opened and closed, for example with the aid of a valve.

The process gas enters the inner gas chamber through the gas inlet. In the case of an embodiment with a gas inlet arranged in the lower region of the heat exchanger, the process gas rises upwards in this inner gas chamber. However, the gas inlet can also be located elsewhere. The upper end of the inner gas chamber is closed, which is why the gas introduced is distributed in the inner gas chamber. According to the invention, it is preferred that the inner gas chamber has a conical end section which is tapered towards the upper end of the heat exchanger.

The inner gas chamber is limited by an inner cylinder wall. This is designed in such a way that it is gas-permeable, but the particles of the solid bulk material essentially cannot pass through the cylinder wall. An exemplary design of the inner cylinder wall is described below.

A hollow cylindrical treatment chamber is arranged around the inner gas chamber. The radius of the treatment chamber is larger than the radius of the inner gas chamber, so that the treatment chamber completely surrounds the inner gas chamber.

The treatment chamber is delimited to the inside by the inner cylinder wall and to the outside by an outer cylinder wall. This is also designed in such a way that it is gas-permeable, but the particles of the solid bulk material are essentially unable to pass through the cylinder wall. An exemplary embodiment of the outer cylinder wall is described below.

The treatment chamber is used to receive and thermally treat a solid bulk material. For this purpose, the treatment chamber is connected to a product inlet in the upper region of the heat exchanger and at least one product outlet in the lower region of the heat exchanger (as defined above). The term “upper region” refers to the upper half, preferably the upper third and particularly preferably the upper quarter of the heat exchanger.

Standard product inlets and outlets can be used. Preferably, these product inlets and outlets can be opened and closed in order to feed and discharge the solid bulk material in a controlled manner. Examples include rotary valves.

According to one embodiment of the present invention, the heat exchanger can have more than one product outlet, for example two product outlets.

The treatment chamber has the shape of an essentially vertically aligned hollow cylinder and is surrounded on the outside by an outer gas chamber. The radius of the treatment chamber is smaller than the radius of the outer gas chamber, so that the outer gas chamber completely surrounds the treatment chamber.

The outer gas chamber is used to discharge the process gas after it has undergone a heat exchange with the solid bulk material in the treatment chamber. For this purpose, the outer gas chamber is connected to a gas outlet that leads through the jacket. The position of the gas outlet is not particularly restricted. For example, the gas outlet can be located in the upper region of the heat exchanger (as defined above). However, it is also possible to arrange the gas outlet in a different region of the heat exchanger, for example in a middle region or in a lower region. If the gas outlet is arranged in the lower region of the heat exchanger, it can also serve as an additional product outlet for removing particles that have entered the outer gas chamber.

Any standard gas outlet can be used. Preferably, the gas outlet can be opened and closed, for example with the aid of a valve.

The outer gas chamber is delimiteded on the inside by the outer cylinder wall and on the outside by the jacket of the heat exchanger.

According to the invention, it is preferred that the outer gas chamber has a conical end section which is tapered towards the lower end of the heat exchanger. It is particularly preferred that an outlet opening is provided at the lower end of the conically tapered end section.

As described above, the inner cylinder wall and the outer cylinder wall are gas-permeable, but are designed in such a way that the particles of the solid bulk material are essentially unable to pass through the cylinder walls. Such walls are well known. Examples include walls made of a suitable material such as a metal, preferably steel, which have openings through which gas can pass. On the other hand, the size of the openings is such that particles of a solid bulk material essentially cannot pass through, as the particle size exceeds the size of the openings.

According to a preferred embodiment, the inner cylinder wall and the outer cylinder wall are formed from a slit plate which is formed from a support structure and profiled bars arranged thereon. Preferably, the profiled bars are arranged on the side of the treatment chamber (i.e. on the side of the corresponding cylinder wall facing the treatment chamber) and are spaced apart from one another such that the particles of the solid bulk material essentially cannot pass through.

The arrangement of the profile bars on the support structure can be vertical or horizontal.

The profiled bars of the outer cylinder wall are particularly preferably arranged vertically towards the treatment chamber (i.e. on the side of the cylinder wall facing the treatment chamber). This enables a better product flow along the profiled bars. In addition, it is particularly preferred that the profiled bars of the inner cylinder wall are arranged horizontally towards the treatment chamber (i.e. on the side of the cylinder wall facing the treatment chamber).

According to the invention, the individual profiled bars are preferably conical and arranged on the support structure in such a way that the wider part faces the treatment chamber and the narrower part faces the support structure. The advantage of such an arrangement is that any small particles that are pressed between the profiled bars are at some point pressed through the bars by the prevailing product pressure, fall into the outer gas chamber and there enter the conical end section and can be removed via an outlet opening.

A key feature of the invention is that the inner cylinder wall has a height that is greater than the height of the outer cylinder wall. This allows the heat exchanger according to the invention to be charged with a larger quantity of gas. Although the dimensions of the heat exchanger remain unchanged (the treatment chamber and the gas chambers are located inside the heat exchanger), more gas can be fed through the inner gas chamber into the treatment chamber in this way. As a result, a more efficient heat exchange treatment can be carried out.

According to the invention, it is preferred that the height of the inner cylinder wall is 1-50%, preferably 5-40%, particularly preferably 10-30% greater than the height of the outer cylinder wall.

The heat exchanger according to the invention can be used to thermally treat a solid bulk material. Preferably, this is a thermal treatment such as heating, drying or cooling. During heating or drying, the process gas has a temperature which is above the temperature of the solid bulk material, whereas during cooling, the solid bulk material has a temperature which is above the temperature of the process gas. Such heat exchange processes are well known.

It is also possible to use the heat exchanger according to the invention to crystallize an amorphous semi-crystallizable material such as PET, as described in EP-3 650 186 A1.

The present invention also relates to a plant for producing a polycondensate, preferably polyethylene terephthalate, comprising a heat exchanger according to the invention, which is preferably arranged as a preheater upstream of an SSP reactor for carrying out solid-phase post-condensation.

According to the invention, the heat exchanger according to the invention is preferably used as a preheater upstream of an SSP reactor for carrying out solid-phase post-condensation.

According to the invention, the solid bulk material is a bulk material consisting of individual, preferably free-flowing particles. The individual particles preferably have an essentially uniform particle size distribution. Nevertheless, the presence of individual very small particles cannot be ruled out. Particles that are less than half the particle diameter of the average particle diameter in at least one dimension are referred to as microparticles.

According to the invention, the solid bulk material is preferably a bulk material of particles of polycondensate, preferably polyester such as polyethylene terephthalate homopolymer or a copolymer thereof.

Suitable polycondensates include crystallizable, thermoplastic polycondensates, such as polyamides, polycarbonates and polyesters including polyhydroxyalkanoates, polylactides or copolymers thereof, which are obtained by a polycondensation reaction with elimination of a low-molecular reaction product. The polycondensation can take place directly between the monomers or via an intermediate product, which is then converted by transesterification, wherein the transesterification can in turn take place with elimination of a low-molecular reaction product or by ring-opening polymerization. The polycondensate obtained in this way is essentially linear, although a small number of branches may be formed.

Semi-crystalline polycondensate pellets refer to polycondensate pellets that have both amorphous zones and zones with a crystalline structure.

Polycondensates of a polymer type are each obtained from the same main monomers. A limited amount of additional monomers, so-called comonomers, can be used.

Polyamides are polymers which are usually obtained by polycondensation from a diamine component with the general structure H₂N—R¹—NH₂ and a dicarboxylic acid component with the general structure HOOC—R²—COOH, where R¹ and R² are usually optionally substituted, linear or branched aliphatic hydrocarbons with 1 to 15 carbon atoms, aromatic or heteroaromatic hydrocarbons with 1 to 3 aromatic rings, cyclic hydrocarbons with 4 to 10 carbon atoms or heterocyclic hydrocarbons with 1 to 3 oxygen or nitrogen atoms and 3 to 10 carbon atoms.

Instead of the dicarboxylic acid, its corresponding dicarboxylic acid halide, preferably dicarboxylic acid chloride, can also be used.

Examples of such polyamides are PA-6,6, which is produced from hexamethylenediamine and adipic acid, or PA-mXD6, which is produced from m-xylylene diamine and adipic acid.

Polyamides are also polymers with repeating amide groups with the general structure H—[N(H)—R—CO]x-OH, where R is usually an optionally substituted, linear or branched aliphatic hydrocarbon with 1 to 15 carbon atoms, an aromatic or heteroaromatic hydrocarbon with 1 to 3 aromatic rings, a cyclic hydrocarbon with 4 to 10 carbon atoms or a heterocyclic hydrocarbon with 1 to 3 oxygen or nitrogen atoms and 3 to 10 carbon atoms.

Polyamides are also polymers which are produced by ring-opening polymerization from heterocyclic monomers with at least one amide group, such as polycaprolactam (PA6) produced from caprolactam.

Polyesters are polymers which are usually obtained by polycondensation from a diol component with the general structure HO—R1-OH and a dicarboxylic acid component with the general structure HOOCR2-COOH, where R1 and R2 are usually optionally substituted, linear or branched aliphatic hydrocarbons having 1 to 15 carbon atoms, aromatic or heteroaromatic hydrocarbons having 1 to 3 aromatic rings, cyclic hydrocarbons having 4 to 10 carbon atoms or heterocyclic hydrocarbons having 1 to 3 oxygen atoms and 3 to 10 carbon atoms.

Usually linear or cyclic diol components and aromatic or heterocyclic dicarboxylic acid components are used. Instead of the dicarboxylic acid, its corresponding diester, usually dimethyl ester, can also be used.

Typical examples of polyesters are polyethylene terephthalate (PET), polybutylene terephthalate (PBT), polytrimethylene terephthalate (PTT), polyethylene furanoate (PEF), polytrimethylene furanoate (PTF), polybutylene succinate (PBS) and polyethylene naphthalate (PEN), which are used either as homopolymers or as copolymers.

One example is polyethylene terephthalate, which is obtained from its monomers, a diol component and a dicarboxylic acid component, with the diol component consisting of ethylene glycol (1,2-ethanediol) as the main monomer and the dicarboxylic acid component consisting of terephthalic acid as the main monomer. Other linear, cyclic or aromatic diol and dicarboxylic acid compounds can be used as comonomers. Typical comonomers are diethylene glycol (DEG), isophthalic acid (IPA) or 1,4-bishydroxymethyl-cyclohexane (CHDM).

Another example is polyethylene furanoate, which is obtained from its monomers, a diol component and a dicarboxylic acid component, with the diol component consisting of ethylene glycol (1,2-ethanediol) as the main monomer and the dicarboxylic acid component consisting of 2,5-furandicarboxylic acid as the main monomer. Other linear, cyclic or aromatic diol and dicarboxylic acid compounds can be used as comonomers. Typical comonomers are diethylene glycol (DEG) or trimethylene glycol.

Polyesters are also polymers with repeating ester groups with the general structure H—[O—R—CO]ₓ—OH, where R is usually an optionally substituted, linear or branched aliphatic hydrocarbon with 1 to 15 carbon atoms, an aromatic or heteroaromatic hydrocarbon with 1 to 3 aromatic rings, a cyclic hydrocarbon with 4 to 10 carbon atoms or a heterocyclic hydrocarbon with 1 to 3 oxygen or nitrogen atoms and 3 to 10 carbon atoms.

One example are polyhydroxyalkanoates with the general structure H—[O—C(R)H—(CH₂)ₙ—CO]ₓ—OH, where R is usually a hydrogen or a linear or branched aliphatic hydrocarbon with 1 to 15 carbon atoms and n is 1 to 10. Examples are poly-4-hydroxybutyrate and poly-3-hydroxyvalerate.

Another example are polylactides with the general structure H—[O—C (R)H—CO]ₓ—OH, where R is usually a methyl group or an aliphatic hydrocarbon with 1 to 15 carbon atoms.

Another example is polyglycolic acid with the general structure H—[O—CH₂—CO]ₓ—OH].

Polyesters are also polymers which are produced by ring-opening polymerization from heterocyclic monomers with one ester group, such as polycaprolactone from caprolactone, or by ring-opening polymerization from heterocyclic monomers with at least two ester groups, such as polylactide from lactide.

The most common polylactide is polylactic acid with the structure H—[O—C(CH₃) H—CO]ₓ—OH. Due to the chirality of lactic acid, various forms of polylactic acid exist. Homopolymers are poly-L-lactide (PLLA), which is usually produced from L, L-lactide, and poly-D-lactide (PDLA), which is usually produced from D, D-lactide.

Copolymers such as poly-(L-lactide-co-D, L-lactide) contain small amounts of lactide units with a chirality that differs from the main monomer.

Polyesters can also be produced by biosynthesis by microorganisms or in plant cells, from which they are obtained by disruption of the cell.

The suitable polycondensates can be crystallizable homopolymers. Despite the term homopolymer, a small proportion of comonomers can form during the manufacturing process. For example, the formation of diethylene glycol from ethylene glycol is known to occur in the production of polyethylene terephthalate. However, many suitable polycondensates are crystallizable copolymers that contain a certain proportion of comonomers. The comonomers may be introduced as part of the monomers in the manufacturing process of the polycondensate or they may form as part of the manufacturing process, usually resulting in a random distribution. The comonomers can also be introduced as blocks made from different monomers, resulting in so-called block copolymers.

Typical amounts of one or more comonomers range from 1% to about 30% w/w. Due to the fact that in many cases an excessive amount of comonomer prevents crystallization altogether, the maximum content of comonomer may be limited to below 20% w/w, preferably below 10% w/w.

Suitable polycondensates can be polymer blends containing any number and amount of different types of polymers. A small amount of a polymer can act as a nucleating agent in polycondensates, thereby increasing their crystallization rate. Specific polycondensate blends can form mutually interacting crystal structures with crystallization behavior that differs from the individual components.

An example of this is a mixture of PDLA and PLLA, which forms a stereocomplex crystal structure with increased crystallinity.

After polymerization, each polycondensate chain has chain-terminating groups usually with the functionality of at least one of its monomers. As an example, a polyester chain may have one or more hydroxyl and/or carboxyl end groups. A polyamide chain may have one or more hydroxyl amine end groups. Such end groups may be modified by a so-called endcapping reagent, or they may be modified by a degradation reaction. Although not specifically mentioned in the general structures above, suitable polymers may have such modified end groups.

The polycondensate can be a new material or a recyclate. Recycled polymers from manufacturing and processing operations (post-industrial) or polymers collected and recycled after consumer use (post-consumer) are referred to as recyclates.

Additives can be added to the polycondensate. Suitable additives include catalysts, dyes and pigments, UV blockers, processing aids, stabilizers, impact modifiers, chemical and physical blowing agents, fillers, nucleating agents, flame retardants, plasticizers, particles that improve barrier or mechanical properties, reinforcing bodies such as spheres or fibres, and reactive substances such as oxygen absorbers, acetaldehyde absorbers or substances that increase molecular weight.

The polycondensates described above can usually be produced in a melt polymerization process up to a certain molecular weight and then transformed in a granulation device into a solid bulk material for further thermal treatment.

A polycondensate melt is fed as starting material to the granulation device for forming a polycondensate granulate. A polycondensate melt is produced using apparatuses or reactors known in the prior art (e.g. Scheirs/Long (eds.), Modern Polyesters, Wiley 2003, in particular pp. 31-104). In principle, polymerization reactors in which polycondensates are produced in the liquid phase, such as stirred tanks, cage reactors or disc reactors, or apparatuses in which previously produced polycondensates are melted, such as extruders or kneaders, can be considered. Polycondensate melt production can take place continuously or in batches. However, continuous processes are preferred for further processing.

In an outlet device, in particular a nozzle or nozzle plate, individual polycondensate strands are formed from the polycondensate melt. The granulation techniques known in the prior art, such as strand granulation, water ring granulation, underwater granulation or head granulation (also known as hot face granulation) can be used to produce pellets (i.e. particles of a defined shape and size) from the polycondensate strands. In this process, the polycondensate strands that emerge from the melt channels are solidified and separated into a large number of individual pellets, whereby the separation can take place before or after solidification. Separation takes place, for example, by independent droplet formation, by the use of a liquid shearing medium or by mechanical separation, in particular cutting. While independent droplet formation or droplet formation forced by a shearing medium takes place at the nozzle outlet, cutting can take place either directly at the nozzle outlet or only after passing through a treatment section.

The polycondensate melt is solidified by cooling with the aid of at least one liquid cooling medium or a combination of different liquid cooling media. Liquids which have a high specific heat capacity, preferably greater than 2 KJ/(kg·K) and a sufficiently high boiling point, preferably greater than 90° C., and which do not substantially attack or alter the polycondensate and do not leave any toxic residues in the polycondensate are particularly suitable as liquid cooling media. According to the invention, a single liquid cooling medium is preferably used. Preferred are water or ethylene glycol or mixtures thereof. Water is particularly preferred as a cooling medium.

The polycondensate, in particular as polycondensate strands or droplets, can, for example, flow through a section containing a process gas, in particular air or water mist, before entering the liquid cooling medium. Despite the use of the term “water” in the designation of the granulation devices, other liquid media can also be used. According to the invention, cooling can take place before, during or after the material is formed into pellets.

Typically, the liquid cooling medium has a temperature of more than 50° C. when it enters the granulation device, but is at least 10° C. below its boiling point. In the case of water, the temperature of the cooling medium according to this embodiment is therefore 50° C. to 90° C. at normal pressure. Due to the pressure dependence of the boiling point, the suitable temperature of the liquid cooling medium increases with increased pressure in the liquid system. At lower pressure, the suitable temperature is reduced, which is also the case in open systems with low external pressure.

Preferably, the liquid cooling medium, preferably water, has a temperature of less than 85° C., particularly preferably between 50° C. and 80° C., especially preferably between 60° C. and 75° C., depending on the Tg of the polycondensate to be formed.

According to a preferred embodiment according to the invention, the liquid cooling medium has a temperature on entering the granulation device which is below the glass transition temperature (also known as the glass transition point, abbreviated as Tg) of the polycondensate to be formed. In the case of polyesters, the pellets begin to stick together above the glass transition temperature of the material, i.e. the particles adhere to each other, forming agglomerates. The glass transition temperature of polyethylene terephthalate, for example, is around 75° C. to 82° C. (depending on the comonomer content and the type of comonomer added). The glass transition temperature of a polycondensate can be determined using a DSC (digital scanning calorimetry) measurement. DSC is a conventional method well known to those skilled in the art. Devices for DSC measurements are also well known and commercially available. One example is the Mettler DSC821 device. To measure the glass transition temperature of a polycondensate such as a polyester, for example 5-25 mg of a corresponding polymer sample can be heated from 25° C. to 290° C. at a rate of 10° C./min in a Mettler DSC821 measuring device. The sample is held at 290° C. for 1 min, then rapidly cooled to room temperature and heated a second time from 25° C. to 290° C. at a rate of 10° C./min. The glass transition point (Tg) is determined from this second pass. The inflection point of the corresponding signal in the DSC is used as Tg.

The pellets produced in this way should preferably have a defined pellet shape, such as cylindrical, spherical, drop-shaped, spherical-like or a design shape, as proposed for example in EP 0 541 674. The average pellet size should be between 0.1 mm and 10 mm, preferably between 0.5 mm and 3.5 mm and particularly preferably between 0.85 mm and 3 mm.

The average pellet size is the statistical mean value of the mean pellet diameter, which is the average of the pellet height, length and width (measurable using known methods). The pellet size distribution should be kept within a narrow range. Preferably, the standard deviation of the granule weights of 100 measured pellets is between 2 and 20%.

According to a preferred embodiment of the present invention, the pellets are subjected to crystallization before entering the heat exchanger according to the invention for preheating. This crystallization may be a conventional crystallization or a direct crystallization.

In another variant according to the invention, the pellets (i.e. the solid bulk material) can be subjected to direct crystallization in the heat exchanger according to the invention, as is known from EP-3 650 186 A1.

In conventional crystallization, the pellets are cooled to a temperature below the crystallization temperature, in particular below the glass transition temperature Tg (e.g. to room temperature). For subsequent crystallization, the pellets must be reheated to a temperature that is within the crystallization temperature range of the polycondensate. This can be done, for example, via a heated wall of the crystallization reactor, via heated internals in the crystallization reactor, by radiation or by blowing in a hot process gas.

In direct crystallization, which comprises both active direct crystallization with the addition of heat and latent heat crystallization, the pellets are not cooled to such an extent (e.g. to room temperature) that they have to be heated for subsequent crystallization with a large amount of energy. Preferably, the pellets are cooled to an average pellet temperature that is within the crystallization temperature range of the polycondensate. This is achieved by selecting the temperature of the cooling medium as described above and selecting a correspondingly short residence time for the pellets in the cooling medium. Preferably, the cooling medium is separated from the granulate within 0.1 to 5 seconds, particularly preferably within 0.3 to 3 seconds after the addition of the cooling medium. At the same time as cooling, the polycondensate pellets can be conveyed to a further process step. The average pellet temperature is the mean value of the temperatures of the individual pellets, wherein each pellet has an average temperature that results when the temperature profile in the pellet is equalized without heat exchange to the outside.

The suitable crystallization temperature range becomes apparent when the crystallization half-life (t½) is plotted as a function of temperature. It is limited upwards and downwards by the temperature at which the crystallization half-life reaches approximately 10 times the minimum crystallization half-life (t½ min). As very short crystallization half-lives (t½) are difficult to determine, t½ min=1 minute is used as the minimum value. For example, the suitable crystallization temperature range for polyethylene terephthalate is between 110 and 220° C., for polyethylene furanoate between 11° and 190° C. and for poly-L-lactide between 8° and 140° C.

The crystallization half-life (t½) is determined by isothermal crystallization using DSC (differential scanning calorimetry). The crystallization half-life corresponds to the time required at the given temperature to reach 50% of the achievable crystallinity. The minimum crystallization half-life (t½ min) is the shortest crystallization half-life obtained in the crystallization temperature range.

Preferably, in the case of polyethylene terephthalate (PET) as the polymer to be treated, the pellets are cooled to a temperature below the crystallization temperature, in particular below the glass transition temperature Tg of about 78° C., or in the case of direct crystallization to a temperature in the range from 110 to 180° C., preferably to between 115° C. and 160° C. and particularly preferably from 120° C. to 150° C.

After cooling to the desired temperature, the cooling medium is separated from the pellets and thus drying is performed. Further treatment (conditioning) of the pellets in a liquid medium is optional, for which the cooling medium or another liquid can be used directly.

The pellets can be separated from a liquid cooling medium by means of separating devices known in the prior art as drying devices. These may only be passive separators, such as grids or grates, through which the cooling medium, but not the pellets, can pass. Active separation devices are usually used for at least part of the separation, wherein the separation can take place, for example, due to gas flow, centrifugal force, impact, vaporization or combinations thereof. Such devices are known, for example, as suction devices, impact dryers or centrifugal dryers. Separation can be assisted by supplying a gas flow into the separation device, wherein the gas flow optionally comprises heated or dried gas, in particular air. A centrifugal dryer with air supply is preferred.

For separation from the cooling medium, the pellets are transferred from a unit described above for forming the pellets via a connecting line into a unit for separating the cooling medium. The pellets are preferably transferred to the separating device at such a speed that the pellets are not cooled below their crystallization temperature range. The flow speed of the pellets in the connecting line can be increased by feeding air or another suitable gas into the connecting line.

For accelerated evaporation of liquid cooling medium, a temperature in the range of 100 to 200° C., preferably 110° C. to 160° C. and particularly preferably 120 to 150° C. is preferably applied. The pellets remain in the dryer, preferably for a period of between a tenth of a second and 10 seconds.

According to the invention, the pellets preferably have a temperature T_{GR} in the range of 100-180° C., preferably from 120° C. to 160° C., after leaving the dryer (separating device).

The separating device has at least one inlet opening for feeding the pellets into the unit. The inlet opening can, for example, be an opening in the housing or the outlet from a pipe that is guided into the housing. Furthermore, the separating device has at least one discharge opening for removing the pellets from the unit. The discharge opening can, for example, be an opening in the housing or the inlet into a pipe that is led out of the housing. Furthermore, the separating device has at least one discharge opening for removing the liquid cooling medium from the unit.

A gas phase is present in the dryer (separating device), which absorbs the evaporating cooling medium. Preferably, the gas is air. However, other gases or gas mixtures with a lower oxygen content than air can also be used.

The separating device is preferably not a self-contained unit. The separating device preferably has at least one outlet opening for discharging gas, preferably air. Preferably, the outlet opening of the separating device opens into a gas discharge line in which a fan is arranged for air circulation through the separating device. Optionally, the outlet opening is connected to a condenser for recovering liquid cooling medium from the discharged gas.

The separating device can also have at least one inlet opening for introducing gas, preferably air. In this case, the inlet opening is preferably arranged at the opposite end of the dryer (separating device) to the outlet opening in order to ensure a complete flow gas through the dryer (separating device). However, it is also possible that the inlet opening for the introduction of gas is not arranged in the separator, but in a downstream unit or a connecting line to a downstream unit.

According to one embodiment, the gas is fed to the inlet opening via an intake filter. A fan can be arranged in the gas line leading to the inlet opening to circulate air through the separating device. This fan can be provided in addition to the fan in the gas discharge line or can take its place.

The line leading to the inlet opening and the line leading from the outlet opening can be connected to each other to form a closed circuit. In this embodiment, however, the gas must be passed through a condenser before re-entering the separating device in order to separate the vaporized cooling medium in the gas. The system according to the invention preferably has a cooling medium circuit. The cooling medium is fed from a storage container (tank) into the forming unit (granulation device), preferably via a circulation pump and possibly a heat exchanger (for optional heating or cooling of the cooling medium). The cooling medium separated in the separating device or any condenser can be fed back into the storage container via a pipe.

After the polycondensate pellets have been separated from the liquid cooling medium, they are transferred to the downstream unit, which comprises a crystallization chamber. Particularly suitable apparatuses for crystallization are fluidized bed apparatuses, such as those described in EP-1 425 146 A2. Heating to crystallization temperature and subsequent crystallization can take place in one or more crystallization apparatuses.

Crystallization can take place in one step or in several steps and thus in one or several successive devices. Crystallization can take place continuously or in batches. Optionally, crystallization can take place in two or more devices operated in parallel.

Preferably, the transfer to the downstream crystallization unit is achieved with the aid of a connecting line, which is arranged between the separating device and the downstream crystallization unit and connects the discharge opening of the separating device to the inlet opening of the downstream crystallization unit. The connecting line is preferably designed in such a way that unhindered passage of the polycondensate pellets to be treated from the upstream unit to the downstream crystallization unit is ensured.

Optionally, a sieve is arranged between the separating device and the downstream crystallization unit, through which individual pellets of the specified size can pass unhindered, but which retains granule agglomerates and excessively large pellets. Optionally, a shut-off unit, preferably a sluice unit such as a rotary valve, is arranged between the separating device and the downstream unit. Several separating devices can be connected to a downstream unit.

In order to avoid time-consuming and costly disposal of material in the event of a fault in the crystallization process, the connecting line can be connected to an intermediate storage tank, as described in WO 2008/071278, into which the material is fed by a control device in the event of a fault and stored there under conditions (in particular lowering of the pellet temperature below its glass transition point) at which agglomeration of the pellets does not occur.

Alternatively, the separating device is connected to the downstream crystallization unit in such a way that the pellets can be transferred directly from the separating device to the downstream crystallization unit.

On entering the downstream crystallization unit, the pellets to be treated are generally essentially amorphous, i.e. they have a degree of crystallization of less than 10%, preferably less than 5%.

Preferably, the polycondensate pellets flow through the crystallization unit essentially from top to bottom, while a process gas flows through the crystallization unit in counterflow or alternatively in crossflow or a combination of counterflow and crossflow. If the heat exchanger according to the invention is used, a crossflow is used.

For example, air, water vapor or inert gases such as nitrogen, noble gases such as argon or CO₂ can be used as process gases. The process gas can comprise a mixture of several process gases. The process gas can contain additives that either act reactively on the polycondensate to be treated, have a swelling effect on the polycondensate or are passively deposited on the polycondensate pellets to be treated. The oxygen content of the process gas should be less than 0.1% by weight, preferably less than 0.05% by weight and particularly preferably less than 0.02% by weight.

In the case of the alternative embodiment, in which the heat exchanger according to the invention is used as a crystallization unit for direct crystallization, the polycondensate pellets are present therein as a fixed bed, which comprises the fixed bed moved in continuous operation.

Preferably, the crystallization unit is arranged below the device for separating the cooling medium/drying. This applies both to a conventional crystallization unit and to the alternative variant in which the heat exchanger according to the invention is used as a crystallization unit for direct crystallization.

The pellets are crystallized in the crystallization unit either passively without external heat supply (so-called latent heat crystallization) or by supplying energy from outside with the help of the hot process gas (so-called active direct crystallization). In the latter case, the process gas is fed into the crystallization unit at a temperature T_{gas} that is greater than the sum of the pellet temperature T_{GR} and the temperature increase T_{KR} by the heat of crystallization released in the crystallization unit, i.e. T_{(gas)}> (T_{GR}+T_{KR}). The gas temperature T_{gas} is therefore higher than the average pellet temperature that the polycondensate pellets would reach in the crystallization unit without external energy input, which has the advantage that the polycondensate pellets can be set to a constant and defined outlet temperature. This applies both to a conventional crystallization unit and to the alternative variant in which the heat exchanger according to the invention is used as a crystallization unit for direct crystallization.

According to the invention, a heat exchanger according to the invention is preferably connected downstream of the crystallization unit in the system according to the invention. Preferably, the pellets are heated in the heat exchanger (even if it is used as a crystallization unit in the variant described above) to the temperature intended for a further thermal treatment stage, for example an SSP reaction. According to a further embodiment according to the invention, no further thermal treatment stage is connected downstream of the heat exchanger according to the invention. A different downstream process or no further stage at all can then follow.

The process according to the invention is carried out in the heat exchanger according to the invention. According to the invention, the mass ratio of gas flow to product flow in the heat exchanger according to the invention should be greater than 1 and less than 10, preferably greater than 2 and less than 10 and in particular preferably greater than 3 and less than 7.

As described above, gas from the inner gas chamber flows through the solid bulk material introduced into the treatment chamber through the product inlet of the heat exchanger in a cross flow, which then enters the outer process chamber and is discharged. The gas has a temperature that is different from the temperature of the solid bulk material. In the case of a preheater, the process gas is hotter than the solid bulk material, but at least 10° C. colder than the melting point of the particles in the solid bulk material.

According to the invention, the gas preferably flows through the inner cylinder wall of the inner gas chamber at a superficial velocity in the range from 0.3 to 0.8 m/s, in particular at 0.4 to 0.7 m/s. Correspondingly, the gas flows through the outer cylinder wall at a superficial velocity of 0.2 to 0.6 m/s, in particular at more than 0.3 m/s. The difference in cylinder height according to the invention allows the difference in gas velocity through the inner and outer cylinder walls to be reduced. It has been shown that the most stable process conditions and the most efficient heat exchange can be obtained in this range.

Since heated process gases are expensive, according to the invention the process gas used is preferably at least partially led in a circulation system, wherein a small amount of exchange gas can be fed in and out in each case. According to this preferred embodiment, there is an essentially closed circuit of pipelines between the discharge unit and the feed unit for the process gas.

There may be other units in the circuit, such as compression devices (e.g. fans, blowers or compressors), heat exchangers (e.g. heaters), shut-off devices (e.g. a valve or tap) or cleaning devices (e.g. filters, cyclones, scrubbers or catalytic combustion devices).

According to a preferred embodiment of the present invention, the heat exchanger according to the invention is connected to an inert gas tank, preferably via a supply line. Inert gas from the inert gas tank can be introduced through the feed line into the circulation system of pipes or directly into the heat exchanger according to the invention. Preferably, a dosing unit, for example a control valve, is arranged in this supply line, with which the supply of inert gas can be controlled.

Gas from a process for further thermal treatment (e.g. an SSP process) can be used as inert gas, wherein is can be used directly or in purified form.

According to a preferred embodiment of the present invention, annealing of the polycondensate pellets takes place in the heat exchanger according to the invention, which acts as a preheater, wherein any low melting peak is shifted to a temperature which is at least 10° above the treatment temperature in the device described below for carrying out a further thermal treatment stage.

The low melting peak can be determined using DSC (digital scanning calorimetry) measurement. To measure the low melting peak of a polycondensate such as a polyester, for example, 5-25 mg of a corresponding polymer sample can be heated in a Mettler DSC821 measuring device at a rate of 10° C./min from room temperature to a temperature above the melting point of the polycondensate. The low melting peak is the peak of the endothermic melting peak that precedes the actual melting peak, whereby mixing of the low melting peak and the melting peak can occur if the low melting peak is located on the flank of the melting peak. In this case, the low melting peak can be determined from the first derivative of the DSC curve, wherein the intermediate minimum on the flank is regarded as the low melting peak.

In the case of polyethylene terephthalate (PET), the pellets preferably have a degree of crystallization of between 20% and 50%, in particular between 31% and 45%, on leaving the heat exchanger according to the invention, and the low melting peak is in the range of 190-250° C., in particular in the range of 200-240° C.

According to the invention, in the case of polyethylene terephthalate (PET), the pellets preferably have an IV value of 0.4 to 0.8 dl/g, in particular 0.55 to 0.75 dl/g, before entering the heat exchanger according to the invention, which acts as a preheater. The IV value indicates the intrinsic viscosity of a polymer and is a measure of its molecular weight. The IV value and its determination are known from the prior art. According to the invention, the intrinsic viscosity (IV) is determined according to the following procedure: To measure the solution viscosity, a mixture of phenol/dichlorobenzene (50:50 wt. %) is used as solvent. The polyester sample is dissolved for 10 minutes at 130° C. with a concentration of 0.5% (0.5 g/dl). The relative viscosity (R.V.) is measured at 25° C. using a Ubbelohde viscometer (according to DIN Instruction No. 53728, Part 3 of January 1985). The relative viscosity is the quotient of the viscosity of the solution and the viscosity of the pure solvent, which is comparable to the ratio of the corresponding capillary flow rate. Huggins' equation is used to calculate the value of the intrinsic viscosity from the measured relative viscosity:

$$I . V . = \frac{\sqrt{1 + 4 KH ( R . V . - 1 )} - 1}{2 * c * KH} ( dl / g )$$

Using the above measurement methods (polymer concentration C=0.5·g/dl and Huggins constant KH=0.35), the equation is as follows:

$$I . V . = \frac{\sqrt{1 + 1.4 ( R . V . - 1 )} - 1}{0.35} ( dl / g )$$

The viscosity of the polyester can be specified either as intrinsic viscosity (IV) or as average molecular weight (numerical average: Mn). To convert an IV value measured in phenol:dichloromethane=1:1 into the average molecular weight, the equation

$$IV = k \cdot {Mn}^{a}$$

is used, where k=2.1·10⁻⁴ and a=0.82.

This equation is generally applicable to published data unless a different solvent mixture and the associated conversion factors are explicitly indicated.

In the plant according to the invention, the polycondensate pellets obtained above can be fed to a further thermal treatment, which is preferably selected from the group consisting of a devolatilization stage, preferably a dealdehydization stage or drying stage, and a solid-phase post-condensation (SSP). This thermal treatment is carried out in a further device, preferably in a separate reactor. Such subsequent thermal treatment is optionally followed by cooling or direct further processing.

Both devolatilization, preferably dealdehydization or drying, and the SSP reaction are known to the skilled person and need not be explained in more detail here. According to the invention, this thermal treatment is preferably carried out in a gas phase of inert gas, wherein volatile components from the solid bulk evaporate during the treatment and pass into the gas phase. Preferably, nitrogen is used as the inert gas. According to the invention, the oxygen content of the gas in the further device should be less than 0.1% by weight, preferably less than 0.05% by weight and particularly preferably less than 0.02% by weight, in order to reduce or exclude oxidative damage to the polycondensate pellets.

Due to the high temperature of the polymer entering the further device, it is not necessary to feed very hot process gas into the further device. Due to the heat of crystallization released, in the case of polyethylene terephthalate (PET) a temperature rise of 2 to 15° C., preferably of 3 to 15° C. and particularly preferably of 5 to 15° C. is generally observed in the further device according to the invention. According to the present invention, a process gas whose temperature is below the temperature of the polycondensate pellets present in the further device can therefore be introduced into the further device in certain cases. The present invention therefore allows subsequent thermal treatment to be carried out in an energy-efficient manner.

In the further device, the process gas is preferably fed in countercurrent to the flow of particles of the solid bulk material. Any reactors known in the prior art for the thermal treatment of bulk solids can be used. For example, a conventional shaft reactor should be mentioned.

The crystallized polycondensate pellets are transferred in a known manner from the heat exchanger according to the invention, which acts as a preheater, to the further device. For example, the pellets can be transferred to the further device by means of pneumatic conveying. Depending on the speed of the conveying, the polycondensate pellets can be cooled by between 2 and 15° C., preferably between 3 and 15° C. and particularly preferably between 5 and 15° C. If necessary, the pellets can be additionally heated in a known manner before entering the further device.

According to the invention, the dealdehydization of polyethylene terephthalate, for example, can take place at a temperature of 140 to 200° C. For example, a temperature increase of 3 to 15° C. can be observed in the additional device.

According to the invention, the SSP reaction of polyethylene terephthalate, for example, can take place at a temperature of 180 to 240° C., preferably 180 to 225° C. For example, a temperature increase of 3 to 15° C. can be observed in the further device.

The present invention is explained in more detail below with reference to a non-limiting drawing. It shows:

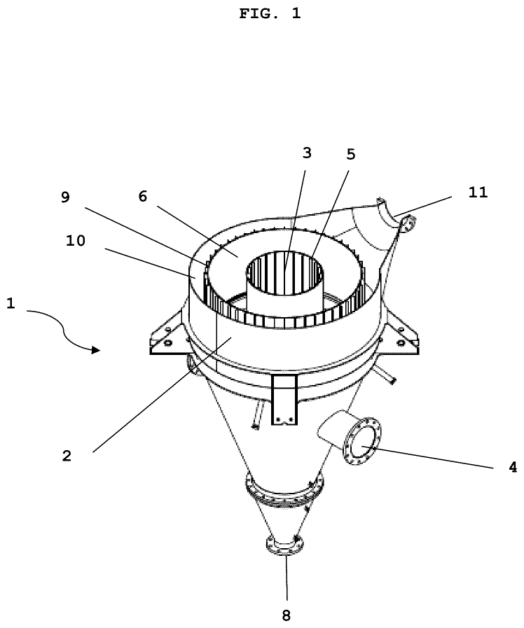

FIG. 1 a schematic representation of a sectional view of a preferred embodiment of a heat exchanger according to the present invention.

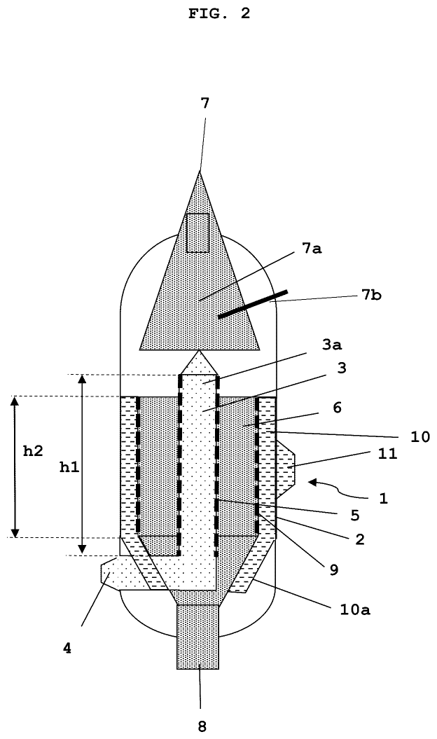

FIG. 2 a schematic side view of the embodiment of the heat exchanger according to FIG. 1.

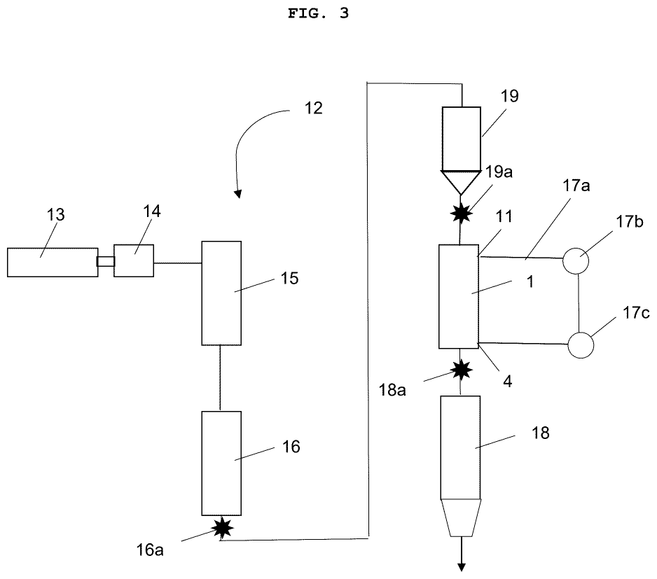

FIG. 3 a schematic representation of a preferred embodiment of a plant according to the present invention.

FIG. 1 is a schematic representation of a preferred embodiment of a heat exchanger according to the present invention. The heat exchanger 1 comprises a jacket 2, a treatment chamber 6 arranged within the jacket 2, which is connected to a product inlet 7 (not shown in FIG. 1) in the upper region of the heat exchanger 1 and at least one product outlet 8 in the lower region of the heat exchanger 1 and has the shape of a substantially vertically aligned hollow cylinder, the hollow cylinder being delimited by an inner cylinder wall 5 and by an outer cylinder wall 9.

The heat exchanger 1 also has an inner cylindrical gas chamber 3 within the inner cylinder wall 5 of the treatment chamber 6, which is connected to a gas inlet 4 arranged in the lower region of the heat exchanger 1.

The heat exchanger 1 also a gas outlet 11, which is connected to an outer hollow cylindrical gas chamber 10, which in turn is arranged between the outer cylinder wall 9 of the treatment chamber 6 and the jacket 2 of the heat exchanger 1.

The inner cylinder wall 5 and the outer cylinder wall 9 are permeable to gas, but the particles of the solid bulk material are essentially unable to pass through the cylinder walls 5, 9.

The heat exchanger 1 according to FIG. 1 is shown open at the top for schematic reasons. However, the heat exchanger 1 according to the invention is closed at the top and only has a product inlet 7 there.

FIG. 2 shows a schematic side view of the embodiment of the heat exchanger according to FIG. 1. Same reference signs describe the same components.

FIG. 2 shows the upper product inlet 7. The conical end sections 3a, 10a of the inner gas chamber 3 and the outer gas chamber 10 can also be seen.

FIG. 2 also shows that the inner cylinder wall 5 has a height h1 that is greater than the height h2 of the outer cylinder wall 9.

FIG. 2 also shows that a distribution region 7a can be located between the upper product inlet 7 and the treatment chamber 6, from which the solid bulk material is fed as uniformly as possible to the treatment chamber 6. To ensure this distribution, it is preferable to ensure that there is always a sufficiently high fill level in the distribution region 7a. This can be ensured, for example, by using a level sensor 7b in the distribution chamber 7a.

FIG. 3 shows a schematic representation of a preferred embodiment of a plant 12 according to the present invention.

The plant 12 according to FIG. 3 has a reactor 13 for producing a polymer melt. This may be a reactor in which a melt polymerization is carried out and a prepolymer is thus produced from the monomers. Alternatively, the reactor 13 can also be a device for melting a solid product, for example a prepolymer. In this case, the reactor 13 can be an extruder, for example.

The molten material is transferred to a granulation device 14. In the granulation device 14, pellets are produced from the molten material in a known manner. For example, it may be an underwater granulator. In this case, granulation takes place under water. The pellets obtained are simultaneously cooled in the granulator 14. As explained above, however, the cooling must not be so strong that the pellets are cooled below their crystallization temperature range. This can be achieved by using heated water which has a temperature above 50° C. but at least 10° C. below its pressure-dependent boiling point, in particular a temperature below the Tg of the polycondensate, preferably a temperature of 50 to 80° C. In the case of polyethylene terephthalate (PET), the pellets should be cooled to a temperature of 110 to 180° C., preferably 115 to 160° C. and particularly preferably 120 to 150° C.

The pellets are transferred to a unit for drying the pellets (separator) 15 via a connecting line. To avoid excessive cooling of the pellets, it should be fed out of the granulator 14 and through the connecting line as quickly as possible. Preferably, the flow rate in the connecting line can be increased by introducing a gas flow (preferably air).

In the unit for drying the pellets (separating device) 15, the pellets are separated from the liquid cooling medium (water) and dried. The separated cooling medium is preferably fed back through a pipe (not shown) into a storage container for the cooling medium, which is connected to the granulation device 14 and from which the cooling medium can be transferred to the granulation device 14.

The drying of the pellets in the unit for drying the pellets (separating device) 15 is preferably carried out, in addition to a mechanical separating device, with the aid of gas, preferably air or a gas atmosphere essentially comprising air, at a temperature of 100 to 200° C., preferably 110 to 160° C.

The pellets are transferred from the separating device 15 via a connecting line (in which a rotary valve, not shown, is preferably arranged) into a crystallization unit 16. The pellets can pass unhindered from the separating device 15 into the unit 16. In an optional embodiment, the unit 16 is a heat exchanger 1 according to the invention, in which case a downstream heat exchanger 1 can usually be dispensed with.

In the unit 16 the essentially amorphous pellets are at least partially crystallized. Inside the unit 16, the pellets are heat-treated either without a gas flow or by a counter-current or cross-current gas flow passing through the unit 16. Unit 16 can, for example, be a rigid container or a moving trough (vibrating trough).

The crystallization of the particles preferably takes place without external energy supply. The crystallized pellets leave the unit 16 via a discharge device, for example a shut-off unit such as a rotary valve 6a.

Alternatively, a second sluice unit (such as a rotary valve) can be arranged downstream of the rotary valve.

The pellets are transferred from the crystallization unit 16 via a connecting line, usually by pneumatic conveying, into a preheater, which is a heat exchanger 1 according to the invention. As shown in the preferred embodiment in FIG. 3, a buffer 19 can be arranged between the crystallization unit 16 and the heat exchanger 1 according to the invention, from which the material can be transferred in a controlled manner into the heat exchanger 1 according to the invention by means of a rotary valve 19a.

A sluice unit such as a rotary valve 18a can be arranged downstream of the heat exchanger 1.

A sufficient fill level in the heat exchanger 1 is preferably ensured either by controlling the sluice unit 18a or 19a based on a measurement signal from the level sensor 7b (not shown here).

The pellets can be fed from the heat exchanger 1 via a connecting line, usually by pneumatic conveying, to a further thermal treatment such as dealdehydization, drying or SSP reaction in a reactor 18. Alternatively, the particles can also be fed directly to a cooling stage. Alternatively, a sluice unit such as a rotary valve (not shown) can be arranged downstream of the reactor 18.

The process gas used in the heat exchanger 1 is preferably fed through a closed circulation system of pipes 17a. The process gas enters the heat exchanger 1 through the inlet opening 4 and leaves the heat exchanger 1 through the outlet opening 11. A fan 17b is located in the circulation system of the process gas to circulate the gas. A further heat exchanger 17c is provided upstream of the inlet opening 4 in order to bring the gas to the desired temperature before it enters the heat exchanger 1. Preferably, the gas is heated in the heat exchanger 17c.

1. A heat exchanger for a solid bulk material, comprising
a jacket,
a treatment chamber arranged within the jacket, which is connected to a product inlet in an upper region of the heat exchanger and at least one product outlet in a lower region of the heat exchanger and has a shape of a substantially vertically aligned hollow cylinder, wherein the hollow cylinder is delimited by an inner cylinder wall and by an outer cylinder wall,
an inner cylindrical gas chamber-within the inner cylinder wall of the treatment chamber, which is connected to a gas inlet,
an outer hollow cylindrical gas chamber between the outer cylinder wall of the treatment chamber and the jacket of the heat exchanger, which is connected to a gas outlet,
wherein the inner cylinder wall and the outer cylinder wall are gas-permeable, but the particles of the solid bulk material cannot pass through the cylinder walls,
wherein the inner cylinder wall has a height h1 which is greater than a height h2 of the outer cylinder wall.

2. The heat exchanger according to claim 1, wherein the height h1 of the inner cylinder wall is 1-50% greater than the height h2 of the outer cylinder wall.

3. The heat exchanger according to claim 1, wherein the inner cylinder wall and the outer cylinder wall are formed from a split plate which is formed from a support structure and profiled bars arranged thereon.

4. The heat exchanger according to claim 3, wherein the profiled bars are arranged on a side of the treatment chamber and are spaced apart from one another in such a way that the particles of the solid bulk material cannot pass through.

5. The heat exchanger according to claim 3, wherein the profiled bars of the outer cylinder wall are arranged vertically towards the treatment chamber.

6. The heat exchanger according to claim 1, wherein the outer gas chamber has a conical end section which is tapered towards a lower end of the heat exchanger.

7. The heat exchanger according to claim 1, wherein the inner gas chamber has a conical end section which is tapered towards an upper end of the heat exchanger.

8. A method for heat treating a solid bulk material in a heat exchanger according to claim 1, comprising the steps of:
a) Introducing the solid bulk material into the heat exchanger through the product inlet of the heat exchanger, so that the solid bulk material enters the treatment chamber of the heat exchanger and flows through the heat exchanger from top to bottom to the at least one product outlet;
b) Introducing a process gas through the gas inlet of the heat exchanger into the inner gas chamber of the heat exchanger, the gas having a temperature which is different from the temperature of the solid bulk material;
c) Heat treatment of the solid bulk material in the treatment chamber by flowing gas from the inner gas chamber through the treatment chamber, wherein the gas flows horizontally from the inner gas chamber through the inner cylinder wall and subsequently through the outer cylinder wall into the outer gas chamber;
d) Discharging the gas from the outer gas chamber through the gas outlet of the heat exchanger.

9. The method according to claim 8, wherein the gas flows through the inner cylinder wall at a superficial velocity in the range from 0.3 to 0.8 m/s.

10. The method according to claim 8, wherein the gas is led in a circuit from the gas outlet to the gas inlet.

11. The method according to claim 10, wherein the gas is purified between the gas outlet and the gas inlet and subjected to a temperature treatment.

12. The method according to claim 8, wherein the solid bulk material is a bulk of particles of polyethylene terephthalate homopolymer or a copolymer thereof.

13. The method according to claim 8, wherein in step c) the temperature of the solid bulk material is increased.

14. The method according to claim 13, wherein in step c) the solid bulk material is heated for a further thermal treatment step.

15. A plant for producing a polycondensate, comprising a heat exchanger according to claim 1.
